(19) United States
(12) Patent Application Publication
(10) Pub. No.: US 2017/0027196 A1
(43) Pub. Date: Feb. 2, 2017

(54) Sterilization of Food in Microwave Interactive Packages

(71) Applicant: Graphic Packaging International, Inc., Atlanta, GA (US)

(72) Inventors: Fermin P. Resurreccion, JR., Thornton, CO (US); Jeffrey T. Sloat, Broomfield, CO (US); Corey Desmond Crooks, Erie, CO (US)

(21) Appl. No.: 15/220,793

(22) Filed: Jul. 27, 2016

Related U.S. Application Data
(60) Provisional application No. 62/198,988, filed on Jul. 30, 2015.

(51) Int. Cl. A23L 3/01; B65B 63/08; B65B 55/14

(52) U.S. Cl. CPC A23L 3/01; B65B 55/14; B65B 63/08; A23V 2002/00

(57) ABSTRACT

An apparatus and method to heat food in a sealed-closed package without having the package open during heating involves disposing a package in a chamber with fluid above atmospheric pressure to engage an exterior of the package with sufficient force to prevent the package from becoming unsealed. The package can include at least a portion that includes a microwave interactive material that interacts with the food during microwave energy exposure and can include areas that substantially reflect microwave energy at areas of the food susceptible to overheating or crisping. The fluid can be a gas, such as air.

### CROSS REFERENCE TO RELATED APPLICATION

This application claims the benefit of U.S. Provisional Patent Application No. 62/198,988, filed Jul. 30, 2015.

### INCORPORATION BY REFERENCE

The disclosure of U.S. Provisional Patent Application No. 62/198,988, which was filed Jul. 30, 2015, is hereby incorporated by reference for all purposes as if presented herein in its entirety.

### BACKGROUND

Microwave energy has been used in thermal sterilization systems, for example, to sterilize food in a sealed-closed package by exposing the food to microwave energy while the package is immersed in pressurized superheated water at sterilization temperature. However, some types of packages can be damaged by immersion in hot water. Additionally, heating and maintaining the water at a high temperature consumes energy.

### SUMMARY

In one aspect, this disclosure details a method of thermally sterilizing food in a sealed-closed package. The thermal sterilization may include microwave heating (i.e., providing microwave energy to) the food in the sealed-closed package while first and second conditions are simultaneously present. As one example, the first condition may comprise the sealed-closed package being immersed in compressed air that is sufficiently above atmospheric pressure so that seal(s) of the sealed-closed package remain substantially intact during the thermal sterilization. The second condition may comprise the food being in the presence of microwave interactive material that is configured to interact with the microwave energy in a manner that enhances sterilization. For example, the sealed-closed package may include microwave interactive material that enhances sterilization by enhancing the uniformity of the microwave heating.

In another aspect, the microwave interactive material may be configured to enhance the uniformity of microwave heating during sterilization. For example and/or as another aspect of this disclosure, the microwave interactive material may be configured to prevent runaway heating at the edge of the food and/or reduce the edge effect of microwave heating. The compressed air, in which the sealed-closed package is immersed during sterilization, can be at about ambient temperature. As compared to a package being immersed in pressurized superheated water during microwave sterilization, the sealed-closed package being immersed in compressed air at about ambient temperature during microwave sterilization may simplify the process, reduce energy consumption and/or allow for the usage of relatively cost-effective packaging materials, such as packaging materials comprising a substantial amount of cellulose (e.g., paper-based materials such as paperboard).

The foregoing presents a simplified summary of some aspects of this disclosure in order to provide a basic understanding. The foregoing is not an extensive summary and is not intended to identify key or critical elements of the disclosure or to delineate the scope of the disclosure. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Reference is made in the following to the accompanying drawings, which are not necessarily drawn to scale. The drawings illustrate examples and should not be construed as limiting the disclosure.

FIG. 1 is a schematic, side cross-sectional view of a portion of a thermal sterilization system, in accordance with an embodiment of this disclosure.

FIG. 2 is a schematic, top pictorial view of a sealed-closed package containing food that is hidden from view within the package, in accordance with an embodiment of this disclosure.

FIG. 3 is an isolated, schematic, top pictorial view of microwave interactive material of the package of FIG. 2, in accordance with an embodiment of this disclosure.

### DETAILED DESCRIPTION

Examples of embodiments are described below and illustrated in the accompanying drawings, in which like numerals refer to like parts throughout the several views. The embodiments described provide examples and should not be interpreted as limiting the scope of the disclosure. Other embodiments, and modifications and improvements of the described embodiments, will occur to those skilled in the art and all such other embodiments, modifications and improvements are within the scope of the present disclosure. For example, features illustrated or described as part of one embodiment can be used in the context of another embodiment to yield a further embodiment, and these further embodiments are within the scope of the present disclosure.

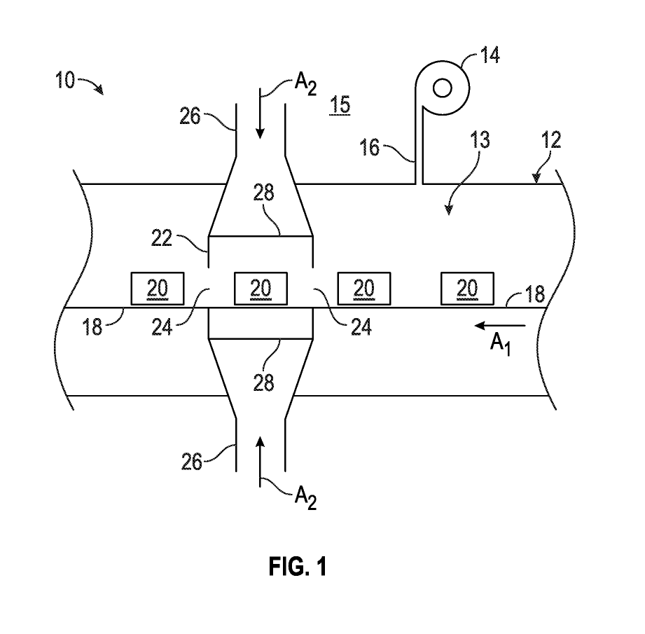

FIG. 1 schematically illustrates a lengthwise portion of a thermal sterilization system 10, in accordance with an embodiment of this disclosure. The sterilization system 10 includes a microwave cavity 12 that can be pressurized and may be referred to as a chamber 12. The interior 13 of the chamber 12 is configured to contain gas (e.g., air) above atmospheric pressure while the exterior 15 of the chamber may be exposed to atmospheric pressure and positioned in an ambient environment. The sterilization system 10 includes at least one source of pressurized gas for pressurizing the interior of the chamber 12. The source of pressurized gas may comprise an air compressor 14 or pump 14 having an inlet open to the ambient environment and an outlet connected to the interior of the chamber 12 by way of a conduit 16, so that the chamber can contain compressed air at ambient or substantially ambient temperature.

The sterilization system 10 may further include one or more valves, pressure gauges, controllers, filters, vents, air conditioners and/or the like that are cooperative with the source(s) of pressurized gas for controlling the atmosphere within the chamber 12. The chamber 12 and associated features may be configured for maintaining the air pressure within the chamber at any suitable pressure, such as, for example, at about 234 kPa. Alternatively, the chamber 12 may contain any other suitable compressed gas(es). The sterilization system 10 may include an airlock system that allows throughput of the packages 20 while maintaining the differential pressure between the interior 13 and exterior 15 of the chamber 12.

At least one support 18 may be positioned in the chamber 12 for supporting at least one package 20 containing a food product (e.g., for example, an entrée, side, dessert, etc.). The support 18 may be a conveyor 18 configured for conveying a series of the packages 20 through at least one heating region 22, e.g., in a direction of travel as indicated by arrow A1. The conveyor 18 may include a pocketed mesh conveyor belt made of non-metallic material, wherein each pocket of the conveyor belt is for receiving and carrying a single package 20. Such a conveyor belt is described in U.S. Pat. No. 7,119,313. The entire disclosure of U.S. Pat. No. 7,119,313 is incorporated herein by reference.

The heating region 22 may be in the form of, or may be at least partially defined by, a cavity 22. The cavity 22 may have openings 24 at each of its opposite ends, with the conveyor 18 extending through the cavity 22 and openings 24. The sterilization system 10 includes at least one microwave device configured to provide microwave energy to the cavity 22 for heating the food in the packages 20 as the packages pass through the cavity. The cavity 22 may be positioned between wave guides 26 of the microwave device. Each wave guide 26 may extend through a wall of the chamber 12 for providing microwave energy to the cavity 22. The passageway through each wave guide 26 may be obstructed with a microwave transparent plate 28 that it is substantially gas impermeable, so as to maintain the suitable pressure tightness of the chamber 12. Suitable materials for the microwave transparent plates 28 may include polymeric or acrylic glass, Plexiglas® acrylic, Ultem® polyetherimide, and/or any other suitable material.

The microwave device may be configured so that the microwave energy provided to the cavity 22 has a frequency of 915 MHz or 2450 MHz, for example, or therebetween. The microwave energy can be provided by a microwave magnetron. The cavity 22 may be configured so that, during operation of the microwave device, there is a single mode electromagnetic field distribution inside the cavity 22. In this regard, the configuration of the cavity 22 may depend upon the frequency of the microwave energy provided by the microwave device. The microwave energy is transmitted to the cavity 22 generally in the direction of arrows A2 and through the microwave transparent plates 28 associated with the wave guides 26. Each wave guide 26 may have a tapered shape, with a wide end connected to the respective microwave transparent plates 28, and a narrow end having an inner cross sectional dimension, which could be, for example, the same as a standard WR975 waveguide (247.7 mm by 123.8 mm) for 915 MHz or a standard WR340 waveguide (86.4 mm by 43.2 mm) for 2450 MHz. Starting from the magnetron, incident microwave energy may be bifurcated at a tee junction configured so that two substantially equal portions of the microwave energy respectively propagate to the wave guides 26 and merge in the center of the cavity 22 without phase shift. Further, the microwave device and cavity 22 may be configured such that only single mode operation is present (i.e., there may be only one pattern of electromagnetic field distribution in the cavity).

An example of a method of using the sterilization system 10 to sterilize at least the food in the packages 20 is described as follows. Prior to the sterilizing, the packages 20 containing food are obtained or otherwise provided. In this example, each package 20 is hermetically sealed closed and includes one or more barrier layers (e.g., high barrier plastics) for substantially restricting (e.g., substantially eliminating) any passage of fluid (liquid or gas), microorganisms, or transmissible agents (e.g., viruses or other pathogens, spores, or the like) between the exterior and interior of the package. Then, for each package 20, the food within the sealed-closed package is heated to a temperature sufficient to sterilize the food. In one example, every area of the food is heated to a temperature of at least about 121° C. for a residence time period that is sufficient to accumulate thermal lethality to achieve a desired microbial log reduction. The heating comprises the package 20 being positioned in the cavity 22 of the chamber 12, so that the sealed-closed package and, thus, the food within the package, is exposed to microwave energy from the microwave device (e.g., wave guides 26). Simultaneously with the heating, the pressure within at least the cavity 22 of the chamber 12 (e.g., the pressure within the interior of the chamber as a whole) is above atmospheric pressure, so that at least one gas (e.g., air) above atmospheric pressure engages at least a portion of (e.g., at least a substantial portion of) the exterior of the sealed-closed package 20 being heated with sufficient force to prevent the package from becoming unsealed due to the increased pressure that occurs in the package during the heating. During operation, the air or other suitable gas(es) in the interior of the chamber 12 may be at a pressure that is greater than the expected internal pressure of the packages 20 being microwave sterilized. For example, during the microwave heating, the chamber 12 may be filled with air at about ambient temperature (e.g., within a range of from about 18° C. to about 27° C., or about 22° C.), and the air pressure within substantially the entire chamber may be about 234 kPa. Alternatively, the air or other suitable gas(es) within the chamber 12 may be at any other suitable temperature and pressure during the microwave heating. For example, the temperature of the air or other suitable gas(es) within the chamber 12 may be substantially above ambient temperature. As another example, the air or gas pressure within substantially the entire chamber 12 may be within a range of from about 175 kPa to about 293 kPa, about 210 kPa to about 257 kPa, or any other suitable pressure.

For minimizing any heat damage to the food, the food in the package 20 that is in the cavity 22 may be quickly microwave heated to the sterilization temperature (e.g., for reducing the residence time needed to accumulate the necessary thermal lethality for sterilization), and thereafter the package and, thus, the food therein, may be quickly cooled in a downstream cooling region (not shown). Any such quick microwave heating to the sterilization temperature is for reducing the residence time needed to accumulate the necessary thermal lethality for sterilization. In the cooling region, the cooling of the package 20 and, thus, the food in the package, may comprise gaseous, cooling convective heat transfer with at least a portion of (e.g., at least a substantial portion of) the exterior of the sealed-closed package. For example, a chamber or cavity of the cooling region may contain air at a temperature below ambient temperature, and the relatively cool air may be forced against at least a portion of (e.g., at least a substantial portion of) the exterior of the sealed-closed package 20. For example, the cooling region may comprise a blast chiller, blast freezer, and/or other suitable devices for quickly cooling the packages 20 and their contents.

Further regarding the option of the food in the package 20 being quickly microwave heated to the sterilization temperature in the cavity 22, the microwave device may be operated at a relatively high power level in an effort to heat the food quickly and/or for maximizing the throughput of the sterilization system 10. Depending upon the configuration of the package 20, the power level at which the microwave device is operated, and other factor(s), the microwave heating may result in non-uniform heating of the food in the package. For example, in some situations, runaway heating may occur in portions (e.g., edges) of the food during the microwave heating.

In accordance with an embodiment of this disclosure, the pockets of the pocketed mesh conveyor 18 and/or packaging material of the packages 20 may comprise microwave interactive material configured in a manner that seeks to enhance the uniformity of the microwave heating in the cavity 22. For example, the microwave interactive material may comprise microwave energy interactive material that is configured to reflect microwave energy, and an area of microwave energy interactive material that is configured to reflect microwave energy may be referred to as a microwave energy shielding element. One or more of the microwave energy shielding elements may be positioned proximate edges of the food for at least partially shielding the edges of the food from the microwave energy in the cavity 22.

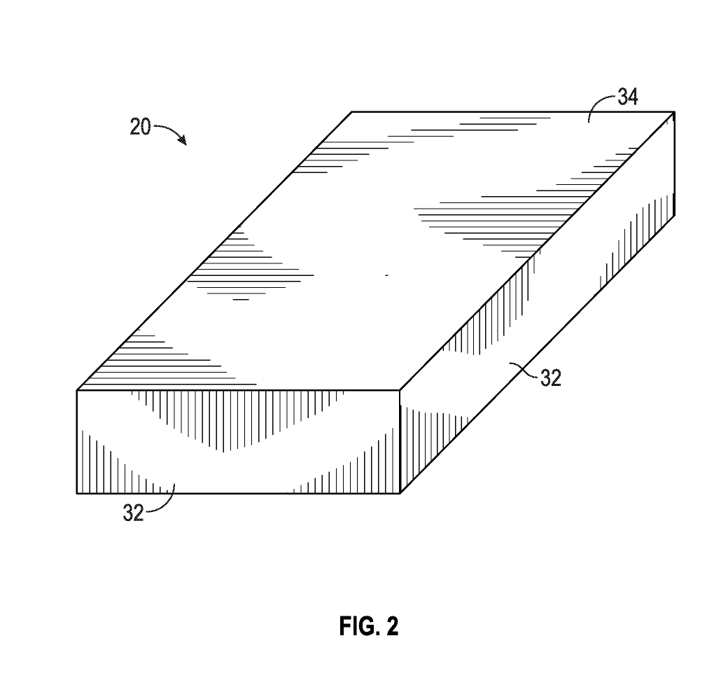

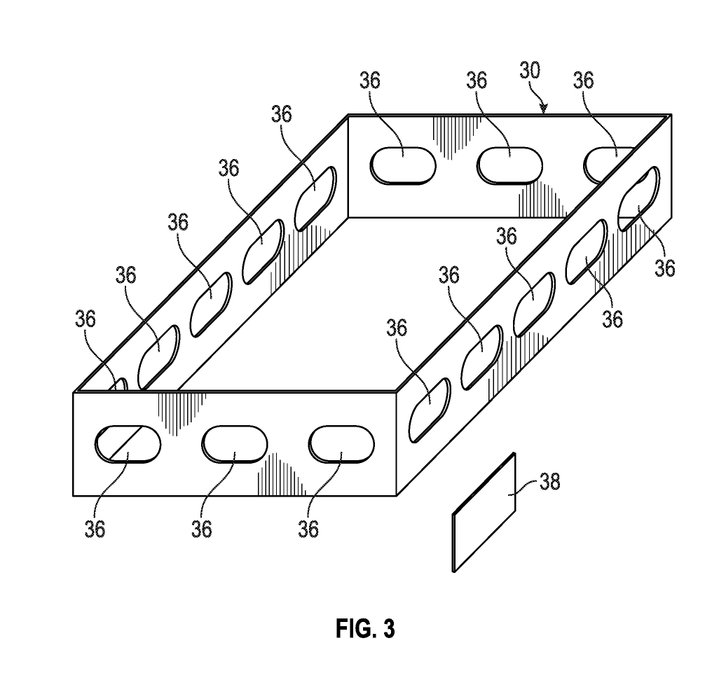

As a more specific example, FIG. 2 schematically illustrates a representative sealed-closed package 20 containing food that is hidden from view within the package, and FIG. 3 schematically illustrates microwave interactive material 30 of the package in isolation. In one example, the package 20 of FIG. 2 can be described as being a substantially parallelepipedal carton 20 formed from packaging material and having sidewalls 32 extending upwardly from a bottom wall to a top wall 34. Referring also to FIG. 3, the microwave interactive material 30 may be in the form of a metal foil band 30 that is positioned at least in the sidewalls 32 and defines obround holes 36 extending there through, wherein the holes are in a spaced apart configuration. The term “obround” can refer to a shape substantially consisting of two semicircles connected by parallel lines tangent to their endpoints.

The microwave interactive material 30, which optionally may be in the form of the band 30, may be used as a shielding element when an associated food item has edges prone to overheating, scorching and/or drying out during the microwave sterilization. The holes 36 can be referred to as transparent elements that are transparent to microwave energy. In some embodiments, the microwave interactive material 30 may be configured as a patch 38 of metal foil having a thickness of from about 5 to about 10 micrometers, for example, about 7 micrometers, or high (greater than about 1.0) optical density evaporated material having a thickness of from about 300 to about 700 or more angstroms. Such elements typically are formed from a conductive, reflective metal or metal alloy, for example, aluminum, copper, or stainless steel, but other suitable materials may be used. An exemplary patch 38 is shown in FIG. 3, with the patch 38 capable of being positioned over a single hole or over multiple holes 36.

The microwave interactive band 30 together with the holes 36 may be cooperative, such as for diffusing or lessening the intensity of microwave energy, such as when these features are parts of the upright sidewalls 32 of the carton 20, a tray, a pouch, or the like. Accordingly, in a second example, the package 20 of FIG. 2 can be described as including a tray, wherein the tray includes sidewalls 32 that may extend both upwardly and outwardly from a bottom wall of the tray, and the tray is hermetically sealed closed by a top cover 34. The tray may be formed from packaging material including the microwave interactive material 30, so that one or more of the sidewalls 32 may include the microwave interactive material 30. The top cover 34 may be in the form of an overwrap and/or lid having a peripheral margin that is hermetically sealed to an annular upper flange extending outwardly from the upper edges of the sidewalls 32. In a third example, the package 20 may be generally schematically representative of a pouch 20 on its side, wherein the pouch is formed from packaging material containing the microwave interactive material 30. Other suitable configurations of the packages 20 are also within the scope of this disclosure. For example, circular or elliptical packages 20 with side-shielding microwave interactive material 30 are also within the scope of this disclosure.

For a variety of configurations of packages 20, the microwave interactive material 30 of the packaging material that at least partially forms the package can be configured for reflecting, diffusing, and/or lessening the intensity of microwave energy. Generally reiterating from above, the microwave interactive material 30 may be configured to be at least one microwave energy reflecting element that may optionally include one or more holes 36, wherein the holes may be transparent to microwave energy. The number and size of the holes 36 may be configured to induce a controlled non-propagating microwave energy that can heat food material proximate the periphery of the sidewall 32 without causing the edge effect of microwave heating. One example of a packaging material generally including a combination of such microwave energy reflecting and transparent elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

In each package 20, the microwave interactive material 30 may be positioned proximate one or more portions of the food that are most likely susceptible to run away heating (i.e., the edge of the food). For example, the microwave interactive material 30 may be, for example, aluminum foil, wherein the aluminum is believed to be a perfect electric conductor that provides a full reflection boundary condition. Thus, it is believed that the electric field in the area of the food prone to runaway heating will be reflected to an area with less concentration of electric field when the aluminum shielding is properly positioned (i.e., field modification). Although the presence of such metal microwave interactive material 30 may change the field distribution inside the package 20, the metal microwave interactive material 30 will not change the single mode operation of the microwave energy inside the cavity 22. Therefore, a predetermined shielding pattern provided by the microwave interactive material 30 of a package 20 may be associated with there being only one field distribution inside the food within the package. The ability to modify the field distribution using shielding microwave interactive material 30 is advantageous in accumulating thermal lethality in the food. A shielding pattern of the microwave interactive material 30 can be configured such that the heating pattern in the food is approximately uniform.

A variety of different configurations or patterns of the microwave interactive material 30 are within the scope of this disclosure. Configurations and patterns of the microwave interactive material 30 may vary depending upon a variety of factors including configurations of the packages 20, the type of food being sterilized, and the like. For example, the microwave interactive material 30 may extend from the sidewalls 32 of a package 20 into the margin of the top wall 34 and/or the margin of bottom wall of the package. Other variations are within the scope of this disclosure.

A variety of packaging materials formed into a variety of packages 20 are within the scope of this disclosure. For example, the packaging material may be a flexible laminate comprising the microwave interactive material 30 and at least one substrate comprising cellulosic and/or polymeric material. As a more specific example, the flexible laminated packaging material of a package 20 may include several layers that are in addition to the at least one layer of microwave interactive material 30, wherein and at least one of the layers may comprise cellulosic material, and at least one of the layers may comprise polymeric material. In the embodiment in which the exterior of the package 20 is exposed to gas, rather than liquid, during the microwave sterilization, the outermost or exterior layer of the packaging material of the package may be conventional, uncoated or clay-coated solid bleached sulfate (SBS) paperboard, uncoated or clay-coated solid unbleached sulfate (SUS) paperboard, uncoated or clay-coated recycled paperboard, uncoated or clay-coated unbleached kraft paperboard, or any other suitable paperboard, or the like. Alternatively, the outermost or exterior layer of the packaging material of the package 20 may be any suitable type of paper or paper-based material, or the like. Paper-based materials, such as paper and paperboard, include cellulose. Alternatively, the outermost or exterior layer of the packaging material of the package 20 may not include cellulose and/or may comprise polymeric material.

As alluded to above, the packaging material of the package 20 typically includes one or more barrier layers (e.g., high barrier plastics) for substantially restricting (e.g., substantially eliminating) any passage of fluid (liquid or gas), microorganisms, or transmissible agents (e.g., viruses or other pathogens, spores, or the like) between the exterior and interior of the package. For example, one or more barrier layers of the packaging material of the package 20 may be in the form of or include ethylene vinyl alcohol (EVOH), barrier nylon and/or any other suitable barrier materials. In accordance with one aspect of this disclosure, foils or films that are transparent to microwave energy would be suitable for use as a barrier layer that entirely encloses all of the food within a package 20 to be subjected microwave sterilization.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

The susceptors, any of the blanks, containers, inserts, or other constructs of this disclosure may optionally include one or more features that alter the effect of microwave energy during the heating or cooking of a food item that is associated with the tray or other construct. For example, the blank, tray, container, or other construct may be formed at least partially from one or more microwave energy interactive elements (hereinafter sometimes referred to as “microwave interactive elements”) that promote heating, browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

In the case of a susceptor or shield, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

The use of other microwave energy interactive elements is also contemplated. In one example, the microwave energy interactive element may comprise a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas may be balanced to attain the desired overall heating characteristics for the particular food item.

As another example, one or more portions of a susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor.

As still another example, a susceptor may incorporate one or more “fuse” elements that limit the propagation of cracks in the susceptor, and thereby control overheating, in areas of the susceptor where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In accordance with the exemplary embodiments, the blanks and/or other constructs may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The above examples are in no way intended to limit the scope of the present disclosure. It will be understood by those skilled in the art that while the present disclosure has been discussed above with reference to examples of embodiments, various additions, modifications and changes can be made thereto without departing from the spirit and scope of the disclosure, some aspects of which are set forth in the claims.

What is claimed is:

1. A method of sterilizing a food product comprising:
obtaining a package containing the food product, the package comprising a seal and a microwave interactive material;
positioning the package in a chamber;
pressurizing the chamber to a pressure above atmospheric pressure;
heating the food product by exposing the package to microwave energy, the microwave interactive material controlling the heating of the food product,
wherein the heating of the food product increases the pressure in the package and the pressurizing of the chamber reduces the pressure differential between the exterior of the package and the interior of the package to prevent failure of the seal during the heating of the food product.

2. The method of claim 1, wherein pressurizing the chamber comprises increasing the pressure of a fluid in the chamber.

3. The method of claim 2, wherein the fluid is a gas.

4. The method of claim 3, wherein the gas is air.

5. The method of claim 2, wherein the pressure of the fluid in the chamber surrounds the package and applies an external force to the package to offset an internal force within the package that is created by the heating the food product.

6. The method of claim 5, wherein the fluid is heated to a temperature above ambient temperature.

7. The method of claim 1, further comprising conveying the package on a support, wherein the positioning the package in the chamber comprise positioning the support in the chamber.

8. The method of claim 7, wherein the support comprises a pocketed mesh conveyor belt made of a non-metallic material.

9. The method of claim 1, further comprising cooling the package in a cooling region downstream of the chamber.

10. The method of claim 1, wherein the microwave interactive material comprises a microwave energy shielding element.

11. The method of claim 10, wherein the package comprises at least one side wall and an opening in the at least one side wall.

12. The method of claim 11, wherein the microwave energy shielding element comprises a reflective element that covers the at least one opening.

13. A system for sterilizing a food product in a package comprising a seal and a microwave interactive material, the system comprising:
a chamber for holding the package with the food product to be sterilized;
a pressurization system for pressurizing the chamber to a pressure above atmospheric pressure;
a heating system for heating the food product by exposing the package to microwave energy, the microwave interactive material controlling the heating of the food product,
wherein the heating system increases the pressure in the package and the pressurization system increases the pressure in the chamber to reduce the pressure differential between the exterior of the package and the interior of the package to prevent failure of the seal during the heating of the food product.

14. The system of claim 13, wherein the pressurization system increases the pressure of a fluid in the chamber.

15. The system of claim 14, wherein the fluid is a gas.

16. The system of claim 15, wherein the gas is air.

17. The system of claim 14, wherein the pressure of the fluid in the chamber surrounds the package and applies an external force to the package to offset an internal force within the package that is created by the heating the food product.

18. The system of claim 17, wherein the fluid is heated to a temperature above ambient temperature.

19. The system of claim 13, further comprising a conveyor system for conveying the package on a support, wherein the conveyor system positions the package in the chamber by positioning the support in the chamber.

20. The system of claim 19, wherein the support comprises a pocketed mesh conveyor belt made of a non-metallic material.

21. The system of claim 13, further comprising a cooling system for cooling the package in a cooling region downstream of the chamber.

22. The system of claim 13, wherein the microwave interactive material comprises a microwave energy shielding element.

23. The system of claim 22, wherein the package comprises at least one side wall and an opening in the at least one side wall.

24. The system of claim 23, wherein the microwave energy shielding element comprises a reflective element that covers the at least one opening.
